(19) United States
(12) Patent Application Publication
(10) Pub. No.: US 2003/0232450 A1
(43) Pub. Date: Dec. 18, 2003

(54) Microfluidic device and method for producing the same

(76) Inventor: Yoshikazu Yoshida, Kawagoe-shi (JP)

Correspondence Address: BIRCH STEWART KOLASCH & BIRCH, PO BOX 747, FALLS CHURCH, VA, 22040-0747, US

(21) Appl. No.: 10/167,468

(22) Filed: Jun. 13, 2002

(51) Int. Cl. G01N 1/10

(52) U.S. Cl. 436/180; 436/174; 436/164; 422/82.05; 422/100

(57) ABSTRACT

A microfluidic device that has a substrate, a resin layer disposed on the substrate and a resin coat on the resin layer, wherein a fluid circuit is formed in the resin layer. A method for producing a microfluidic device, with the method including forming a resin layer on a substrate, ablating this resin layer by laser processing to form a groove having a predetermined pattern, which groove is to be a fluid channel, and thereafter laminating a resin coat on the entire surface of the processed resin layer to form a fluid circuit.

### FIELD OF THE INVENTION

The present invention relates to a microfluidic device and a method for producing the same, and particularly to a microfluidic device preferable to embody a so-called μ-TAS (Micro/Miniaturized Total Analysis System), and to a method for producing the microfluidic device.

### BACKGROUND ART

There have been increased needs for developing miniature devices and highly sensitive detecting methods in recent years, aimed at analyzing the components of trace fluids, such as DNAs and toxic substances, in various fields, including studies of genes and criminal investigations. For this, a μ-TAS (Micro/Miniaturized Total Analysis System), in which a micro-channel, a sampling section, a filter, a column, and a detector are integrated on a substrate, to produce a chemical analysis system for analyzing the components of fluids and the like by using micro machining technologies, has attracted considerable attention. For high-accuracy analysis using a small amount of a sample, spectral analysis methods, such as a fluorometric analysis method, which are used most widely at present, have many deficiencies. There has been no report concerning merits in the point of detection sensitivity even if the device is miniaturized. On the other hand, it can be expected that a μ-TAS enables measurement using only a small amount of a sample or a reagent.

Also, in medical fields, very expensive and large-scale biochemical analyzers are inevitably used as the last resort for measurements of various parameters, such as various proteins, hormones, and antigen antibodies, including counting of numbers of red blood corpuscles or white blood corpuscles. Study is proceeding to apply a μ-TAS to such measurement as this, thereby carrying out such analysis and measurement promptly, with high sensitivity. Moreover, the use of a μ-TAS enables simplifying the exchange of parts, and freedom from concern about infection in blood analysis, and such use is expected to contribute to the development of sanitation in medical fields.

The μ-TAS is expected to play an active role part in the field of genetic information (DNA) analysis, which is being studied most popularly in many countries, including the U.S., besides the aforementioned fields. Experiments have been made aiming at, as one of their final targets, performing treatment fitting to an individual, and that treatment would be realized by decoding the DNA of the human completely to find the causes of intractable diseases at the gene level. For this purpose, μ-TAS technologies are also expected from the viewpoint of decoding genes on the level of an individual rapidly and precisely.

As for the system itself, μ-TAS can be small-sized, it can be produced at low cost, and it can reduce dead volume. Also, it can remarkably decrease the amounts of samples and reagents required for measurement, and also the amount of waste generated in analysis. These many advantages of the μ-TAS allow it to be expected to be applied and developed in various fields.

As a μ-TAS like this, one provided with miniaturized channels, and analyzing and detecting sections, which are combined and secured to a substrate, is conventionally proposed.

In such a conventional μ-TAS, it is required to wash the whole system each time it is used, or it is required to dispose of it, particularly in medical fields, and analysis of genetic information. However, a μ-TAS like this is itself a very expensive miniature system, and it is therefore desired to develop systems and devices that are not all disposed of after each use.

### SUMMARY OF THE INVENTION

The present invention resides in a microfluidic device comprising a substrate, a resin layer disposed on the substrate, and a resin coat covering the resin layer, wherein a fluid circuit is formed in the resin layer.

The present invention also resides in a method of producing a microfluidic device, with the method comprising forming a resin layer on a substrate, removing this resin layer by laser processing, to form a groove having a predetermined pattern, which groove is to be a fluid channel, and thereafter laminating a resin coat on the whole surface of the processed resin layer, to form a fluid circuit.

Also, the microfluidic device of the present invention enables a μ-TAS ensuring that not all of the materials contaminated with each measurement and analysis are disposed of, and the main parts can be regenerated and reused.

Other and further features, and advantages of the invention will appear more fully from the following description, take in connection with the accompanying drawings.

### BRIEF DESCRIPTION OF THE DRAWINGS

FIG. 1(a) to FIG. 1(d) are explanatory views illustrating one example of a step of producing a microfluidic device according to the present invention.

FIG. 2 is a graph showing the relationship between the travel speed of laser light in laser processing used in a production method according to the present invention, and the depth of a groove.

FIG. 3(a) to FIG. 3(d) are explanatory views illustrating one example of a step of producing a microfluidic device according to the present invention, when a gold deposition electrode is formed on a substrate.

FIG. 4 is an explanatory view of an enlarged photograph of an electrode and a groove formed on a resin part, as viewed from the backside of a quartz substrate of a microfluidic device obtained as a preferable example of the present invention.

### DETAILED DESCRIPTION OF THE INVENTION

According to the present invention, the following measures are provided:

(1) A microfluidic device comprising a substrate, a resin layer disposed on the substrate, and a resin coat covering the resin layer, in which a fluid circuit is being formed in the resin layer.

(2) A microfluidic device according to (1), wherein the substrate is selected from silicon, glass, or ceramics.

(3) A microfluidic device according to (1), wherein the fluid circuit is made with a groove that is formed by laser processing and that has at least one portion where a surface of the substrate constitutes a bottom surface of the groove.

(4) A microfluidic device according to (3), wherein the fluid circuit is formed by coating the resin layer including the groove part, with resin lamination.

(5) A method of producing a microfluidic device, comprising the steps of forming a resin layer on a substrate, ablating this resin layer by laser processing, to form a groove having a predetermined pattern, which groove is to be a fluid channel, and thereafter laminating a resin coat on the entire surface of the processed resin layer, to form a fluid circuit.

(6) A method of producing a microfluidic device according to (5), comprising reusing the substrate by washing away the resin layer and the resin coat on the substrate.

(7) An analysis method using the microfluidic device according to (1), comprising conducting optical analysis by applying light from the side opposite to the surface of the substrate on which surface the fluid circuit is formed in the microfluidic device.

(8) An analysis method using the microfluidic device according to (1), wherein an electric wire is formed on the substrate, for conducting electrochemical analysis.

(9) A microfluidic device comprising a substrate, a resin layer disposed on the substrate, and a thermosetting resin film laminated so as to cover the resin layer, in which a fluid circuit is being formed in the resin layer.

The method of producing the microfluidic device of the present invention will be first explained with reference to the drawings.

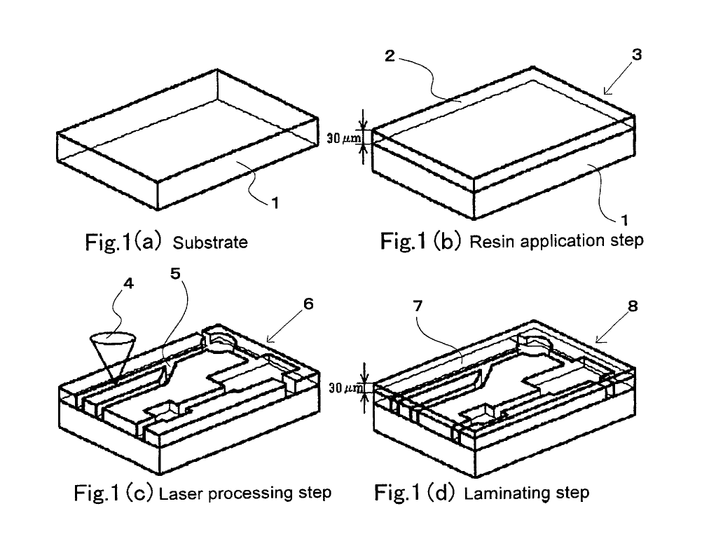

FIGS. 1(a) to 1(d) illustrate production steps of the microfluidic device according to the present invention, taking a μ-TAS as an example.

FIG. 1(a) illustrates a substrate 1, made of silicon or the like; and FIG. 1(b) illustrates a resin layer-formed substrate 3 before laser processing, wherein the substrate 1 is coated with a resin layer 2, made of a BCB or the like, which will be explained later. FIG. 1(c) illustrates a laser processing step and is a perspective view showing a state in which the resin layer-formed substrate 3 is processed by laser light 4, to form a channel 5. No particular limitation is imposed on a method of forming the channel 5 by the laser light 4, and as this method, for example, there are a method in which a light source of laser light is moved to carry out scanning exposure in accordance with an object circuit pattern (the width and depth of a groove and the shape of a circuit) to be formed, and a method in which a laser light source is fixed, and the substrate 3 is made to travel relatively to the laser light, such that a pattern in accordance with an object circuit is formed. By this laser processing, the channel 5, which is to compose an inlet, a flow section, a mixing/reaction section, an analysis section, a reserving section, a detection section, and an outlet, is formed. The difference in the shape of the channel 5 of FIG. 1(c) between positions corresponds to that between each object of sections of the channel. A substrate 6, on which a resin channel is formed, is produced in this manner.

Next, as shown in FIG. 1(d), a laminate 7 is formed on the upper surface of the substrate provided with the channel 5, to cover all the structural elements, thereby manufacturing a microfluidic device 8.

As the substrate in the present invention, such plastics as Teflon (trade name, polytetrafluoroethylene) and the like, besides such inorganic materials as silicon, glass (quartz glass), synthetic quartz, ceramics, and metals, may be used. In the case of conducting analysis by applying light from the side (lower surface) opposite to the surface of the microfluidic device of FIG. 1(d), on which surface the circuit is formed, it is preferable to use a light-transmittable material, such as quartz, as the substrate. Although no particular limitation is imposed on the thickness of the substrate, the thickness is preferably in a range from 0.1 to 5 mm, and more preferably in a range from 0.4 to 1 mm.

Although there is no particular limitation also to the thickness of the resin layer to be applied to the substrate, the thickness is preferably 10 to 1000 μm, and more preferably 20 to 50 μm. The thickness of the resin layer is determined in relation to the type of a measurement, and the amount of a sample required for the measurement. When the thickness is excessive, it is difficult to carry out laser processing, whereas when the thickness is too thin, a fluid, such as a sample solution, does not flow. As the resin to be used, any one of resins that are easily applied to the substrate by a spin coating method, laminating method, or the like, and that are other than those that react with a sample for analysis and elute in the sample, may be used, and resins that can be washed away with ease after use are desirable, to reduce costs and to simplify washing and exchange. The use of such a resin ensures that not all of the parts must be disposed of, so that the silicon substrate can be reused.

As the resin, any resin may be used as long as it satisfies the above requirements. Examples of the resin include benzocyclobutene resin (BCB) and fluorocarbon resins, such as Teflon. The thickness of the resin layer 2 is usually designed to be the same as the depth of the groove of the channel 5. However, the resin may be left partially, according to the function of some parts of the channel circuit. Also, in the case of carrying out photo detection, even if the resin is left partially, this is no problem as long as the size of the residual portion is less than the wavelength of the detection light.

The processing for forming the channel in the resin layer is preferably performed by laser processing. As the laser, an ultraviolet laser is preferable.

Processing reduced in thermal effects can be attained by processing using ultraviolet light. In mechanical processing and the like, it is difficult to carry out precise processing due to strain or damage caused by heat. However, processing using an ultraviolet laser decreases the generation of heat, thereby suppressing the reduction in accuracy caused by the heat, of a processed material. Further, the convergency of a laser is largely dependent on its wavelength, and the shorter the wavelength is, the better the convergency is. Therefore, processing using an ultraviolet laser may be utilized for precise processing and fine processing for which high accuracy is needed. Also, the resistance to the generation of heat makes it possible to process materials such as resins, which are easily affected by heat.

Among these ultraviolet laser lights, a preferable ultraviolet laser light has a wavelength ranging preferably from 350 nm or less, and more preferably from 150 to 300 nm.

In the case of processing using ultraviolet laser light in the present invention, it is considered that the groove is formed by a laser ablation phenomenon. This mechanism is considered to be as follows. When a high molecular material is irradiated with an ultraviolet laser, a molecular bond is cut, and the material is vaporized. (a) When, first, the high molecular material is irradiated with an ultraviolet laser having, for example, a wavelength of 250 nm, for several tens of ns, (b) excited molecules and various activated species are generated at high density on the surface of the high molecular material. (c) When the energy received from the laser by the molecule is greater than that required for the chemical bond constituting the molecule (when the energy exceeds the work threshold that is the value intrinsic to the material), the chemical bond is cut, and the material is decomposed at the molecular or atomic level. This causes rapid volumetric expansion. (d) At this time, the energy given excessively is converted into kinematic energy of the molecule, and the molecule is ejected into an open space above the processed material, and is therefore removed.

After the channel is formed, laminate processing is carried out, as aforementioned. As to lamination processing itself, several types of method are known, and lamination may be carried out using any type of these. As specific example of the method, extrusion lamination, dry lamination, and wet lamination are typical in the case of laminating a plastic film.

The thickness of the laminate 7 may be of an order sufficient to cover the upper surface of the resin layer formed by resin coating, thereby sealing the upper surface of the channel completely, and sufficient to give adequate strength to form a fluid circuit having a prescribed pattern in the microfluidic device. The thickness of such a laminate is generally 10 to 200 μm, and preferably 20 to 100 μm.

In the case of employing a plastic film for lamination, though no particular limitation is imposed on its type, a thermosetting resin film is preferable, because a plastic film made of the resin imparts sufficient strength to the microfluidic device, and the film scarcely penetrates into the formed channel at the time of lamination processing. Preferably the thermosetting resin film is cured under heating further after laminate processing.

The microfluidic device of the present invention may be applied to known various types of μ-TAS, as mentioned in the paragraph “BACKGROUND ART.” Some examples of detection methods used in these types of μ-TAS will be explained.

1) Electrochemical Detection Method

This detection method is suitable to the present invention from the viewpoint of integrating a chemical system on one substrate, because a detecting part is also integrated on a substrate. A microelectrode can be produced easily on a substrate by using micromachining technologies. This detection method also requires no light source, and it can be an ideal detection method for microchemical systems.

2) Chemiluminescence Method

A detection method utilizing chemiluminescence requires neither an external light source, such as a laser, nor a complex optical system, such as a microscope, because the reaction system itself emits light, and the method only requires a highly sensitive photodetector. Therefore, this detection method is an ideal method to integrate, as in the case of a microelectrode.

3) Electrochemiluminescence Method

This electrochemiluminescence method can control chemiluminescence by applying voltage to an electrode, and therefore it is simple and ensures reliable results.

The microfluidic device of the present invention can be restored to the original silicon substrate by washing the resin layer, using a solvent.

The microfluidic device of the present invention can be decreased in cost and can attain simplification of washing and exchanging operations by using a substrate like a silicon substrate, which has been widely used for substrates in recent years, and it is obtained at low cost and by coating the substrate with a resin by spin coating, to form a channel at the resin portion. Further, the used resin portion can be washed away. This brings about the result that not all of parts must be disposed of, and therefore the substrate can be reused. If this microfluidic device is used, the μ-TAS can be put into practice more easily. Moreover, because in this microfluidic device, the channel is formed in the resin layer, this microfluidic device has the advantage that patterns of a groove and the like can be changed, the processing step can be shortened, and trial manufacture of a fluid system on a chip can be attained promptly and easily, and further, the range of the selection of a processing subject (e.g. a resin) is broadened. Moreover, the microfluidic device of the present invention produces such an excellent effect that accurate and fine processing can be attained, and application to materials that are easily affected by heat is enabled, because the use of an ultraviolet light laser decreases the effect of heat on the material.

Also, the microfluidic device of the present invention enables a μ-TAS in which materials polluted after each measurement and analysis are not disposed of and can be regenerated and reused. Further, the present invention also provides a method for producing a microfluidic device that can be applied to a μ-TAS that simplifies the aforementioned regeneration and reuse.

The present invention will be described in more detail based on examples given below, but the present invention is not limited by these examples.

### EXAMPLES

### Example 1

A sample was processed by making it travel at velocities of 1.00 mm/s, 0.75 mm/s, 0.50 mm/s, and 0.25 mm/s, in each laser output condition of 1.1 mJ, 2.1 mJ, 3.5 mJ, and 5.5 mJ per shot, to find a laser condition under which only a 30-μm-thick BCB resin portion applied to a silicon substrate could be processed.

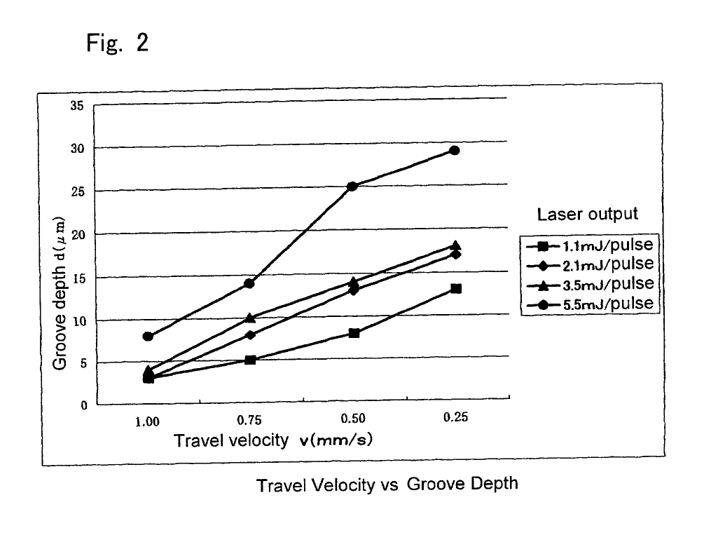

FIG. 2 is a graph showing the relationship between the travel velocity v of the sample to be processed and the groove depth d in each obtained laser output.

The section of the processed portion that was processed at each travel velocity v and a laser output of 5.5 mJ/shot was observed in a microphotograph. It was found that, in the processing at a laser output of 5.5 mJ, the resin portion was processed until the processing reached the position immediately in front of the silicon substrate when v=0.50 mm/s. However, when v=0.25 mm/s of (d), the influence of the laser appeared on even the silicon substrate in the vicinity of the deepest portion of the processed portion, and it was considered that the silicon substrate was damaged. In this case, the sample could be processed at a travel velocity v lower than 0.25 mm, so as not to damage the silicon substrate.

### Example 2

A microfluidic device according to the present invention was produced according to the steps shown in FIGS. 1(a) to 1(d).

A 30-μm-thick BCB resin film was produced on a 380-μm-thick silicon substrate by spin coating. The coated resin portion was processed using an ultraviolet laser, to form a channel of width 30 μm and a depth ranging up to 30 μm, thereby producing a substrate 6 (shown in FIG. 1(c)). Next, a fluororesin, 30 μm in thickness, was laminated on the substrate, to cover the entire surface, thereby producing a microfluidic device.

### Example 3

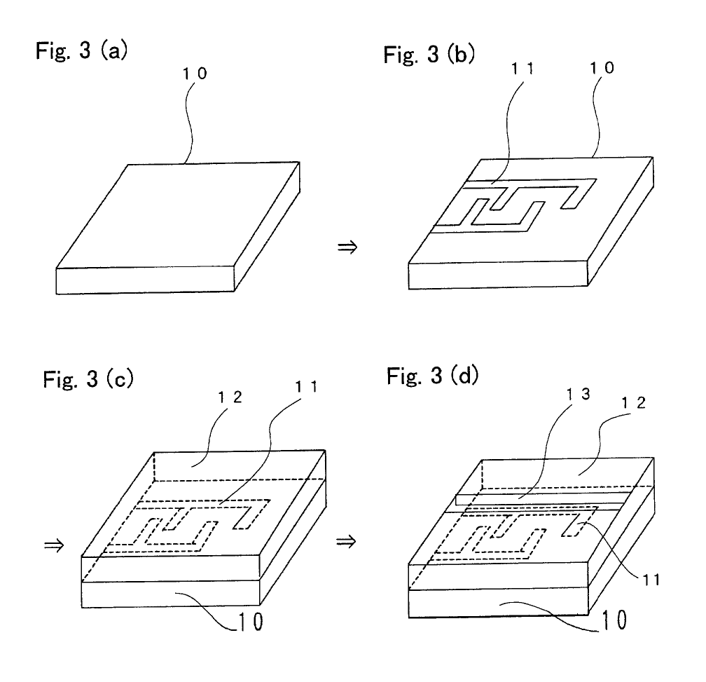

A gold deposition electrode 11, as shown in FIG. 3(b), was formed on a quartz substrate 10, of thickness 380 μm, as shown in FIG. 3(a), to form a substrate, and to which substrate a BCB resin film 12 was applied, at a thickness of 25 μm, by spin coating. This state is shown in FIG. 3(c). This resin film was processed using a 250 nm ultraviolet laser, with a pulse energy of 10 mJ, at 10 shots/sec, to form a groove 13 of width 50 μm and depth 25 μm. This state is shown in FIG. 3(d). Next, a fluororesin, 30 μm in thickness, was laminated (not shown) on BCB resin film that had been processed by a laser in the same manner as in Example 2, to cover the entire structural elements. When a fluid sample is allowed to flow through the fluid circuit, consisting of the groove 13 formed in the above described manner, it becomes possible to conduct electrochemical analysis of the fluid sample placed between the electrodes, because the gold deposition electrode intersected with the groove.

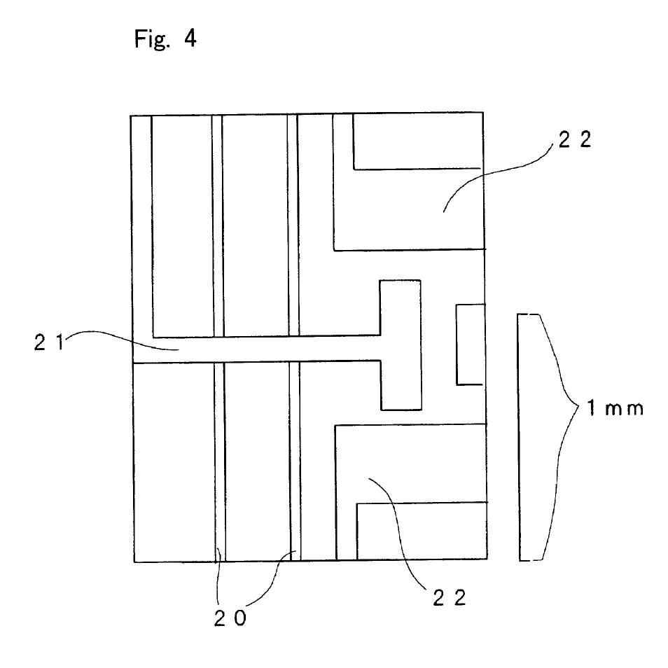

FIG. 4 shows a drawing copied from a microphotograph (magnification: 50×) of another example of a microfluidic device, into which the electrode formed in the above manner was incorporated, as it was, as viewed from the side of a quartz substrate (transparent). In the drawing, 20 represents a groove, 21 represents an electrode, and 22 represents a pad. The quartz substrate exists on the front side of the paper on which the drawing is illustrated.

### Example 4

A 20-μm-thick BCB resin film was produced on a 380-μm-thick silicon substrate by spin coating. The coated resin portion was processed using a ultraviolet laser, to form a channel of depth 20 μm, length 30 mm, and width 100 μm, thereby forming a substrate. A thermosetting resin film (Nikaflex, manufactured by NIKKAN INDUSTRIES CO., LTD.), prepared by applying a 20-μm-thick epoxy resin (EP), as an adhesive, to 25-μm-thick polyimide (IP), was placed on this substrate. A roller of a laminate processing machine (Fast Laminator VA-400, manufactured by Taisei Laminator Co.) was heated to 120° C., and it was rotated with applying pressure to the substrate side, so as to laminate the substrate by pressing a film to the substrate under pressure, to cover the entire surface, and thereby a microfluidic device was obtained. The feed rate of the film driven by the roller was designed to be 0.2 m/min, and the pressure of the roller pressing the film to the surface of the film was designed to be 0.8 MPa. After the lamination processing was finished, the substrate was placed in a thermostat kept at 120° C., to heat-cure the resin film, for 30 minutes.

A laser microphotograph of the section of the silicon substrate after the film was cured was observed, to find that the film was stretched so as to form a shield, which sufficiently secured the formed channel.

### Example 5

A 30-μm-thick BCB resin film was produced on a 400-μm-thick quartz substrate by spin coating. The coated resin portion was processed using an ultraviolet laser, a channel was formed, and lamination processing was performed, to form a microfluidic device, in the same manner as in Example 4. After the lamination processing was finished, the substrate was placed in a thermostat kept at 120° C., to heat-cure the resin film, for 30 minutes.

To form an inlet for introducing a sample, processing to open a hole penetrating through the film and reaching the channel was performed, using a KrF excimer laser (INDEX848, manufactured by SUMITOMO HEAVY INDUSTRIES, LTD.). The laser light was reformed with a mask, and the spot was made square. Then, the laser light was converged through a lens. Also, the material to be processed was moved using an XY-stage. The positioning accuracy of the XY-stage was ±5 μm.

The processing was carried out from the surface of the film to a depth of 25 μm in the following conditions: energy, 350 mJ; 50 Hz, and 40 shots/sec, to form an angular-type hole of 150 μm×150 μm. A 100 μm×100 μm angular through-hole reaching the channel was formed in the center of the hole in the following conditions: energy, 350 mJ; 50 Hz, and 50 shots/sec, to form the sample-introduction inlet.

An outlet was formed by processing in the same manner as in the case of the inlet at a position 3 cm away from the inlet on the channel.

The resin was processed in a desired thickness with no burrs produced, using the KrF excimer laser.

### Example 6

A silica tube (manufactured by SEG, Inc.; outside diameter, 140 μm; inside diameter, 100 μm) was vertically set to the film through-hole reaching the channel of the microfluidic device produced in Example 5. The silica tube was set such that its lower end was located at the step worked position formed on the part of the film. Further, to prevent the adhesive from intruding into the channel, the silica tube was supported by inserting it into a PEEK (polyethyl ethyl ketone) tube shorter than the silica tube. The outer periphery of the lower end of the PEEK tube was stuck to the surface of the film, using an epoxy type adhesive, to secure the PEEK tube. Next, the silica tube was stuck to the upper end of the PEEK tube, to secure it. A micropump was connected to the silica tube, to introduce pure water into the channel.

As the micropump, a microflow pump (ULTRA-PLUS II, manufactured by Micro-Tech Scientific, Inc.), provided with an injector, for injecting a sample to be analyzed, was used. Pure water was fed by the pump at a feed rate of 3.0 μL/min, and as a result, it was confirmed that the pure water could be fed in a stationary and constant speed condition and discharged from the outlet, without generating pulsating flow even when a micro amount of water was fed.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A microfluidic device comprising a substrate, a resin layer disposed on the substrate, and a resin coat covering the resin layer, in which a fluid circuit is being formed in the resin layer.

2. A microfluidic device according to claim 1, wherein the substrate is selected from silicon, glass, synthetic quarts, or ceramics.

3. A microfluidic device according to claim 1, wherein the fluid circuit is made with a groove that is formed by laser processing and that has at least one portion where a surface of the substrate constitutes a bottom surface of the groove.

4. A microfluidic device according to claim 3, wherein the fluid circuit is formed by coating the resin layer including the groove part, with resin lamination.

5. A method of producing a microfluidic device, comprising the steps of forming a resin layer on a substrate, ablating this resin layer by laser processing to form a groove having a predetermined pattern, which groove is to be a fluid channel, and thereafter laminating a resin coat on the entire surface of the processed resin layer to form a fluid circuit.

6. A method of producing a microfluidic device according to claim 5, comprising reusing the substrate by washing away the resin layer and the resin coat on the substrate.

7. An analysis method using the microfluidic device as claimed in claim 1, comprising conducting optical analysis by applying light from the side opposite to the surface of the substrate on which surface the fluid circuit is formed in the microfluidic device.

8. An analysis method using the microfluidic device as claimed in claim 1, wherein an electric wire is formed on the substrate, for conducting electrochemical analysis.

9. A microfluidic device comprising a substrate, a resin layer disposed on the substrate and a thermosetting resin film laminated so as to cover the resin layer, in which a fluid circuit is being formed in the resin layer.
